(19) United States
(12) Patent Application Publication
(10) Pub. No.: US 2009/0038889 A1
(43) Pub. Date: Feb. 12, 2009

(54) Portable non-motorized automatic lift and transport system for small vehicles

(76) Inventor: Joseph D. Whitney, Dallas, TX (US)

Correspondence Address: Joseph D. Whitney, 1652 Sylvan Ave., Dallas, TX, 75208, US

(21) Appl. No.: 11/891,189

(22) Filed: Aug. 10, 2007

(51) Int. Cl. B66F 7/00

(52) U.S. Cl. 187/210

(57) ABSTRACT

A non-motorized low cost lift with an attached platform whose platform lifting mechanism is activated by the wheels of a motorized wheelchair, motorcycle, ATV, tiller or other small motorized equipment. A vehicle coupling assembly attached hereto that transports the lift assembly and a safety device that holds the elevated platform and vehicle in place. Whereby a wheelchair, motorcycle, ATV, tiller or other motorized vehicle can be safely attached, quickly elevated and transported.

### CROSS REFERENCE TO RELATED APPLICATIONS

Not Applicable

### FIELD OF INVENTION

The present invention relates to a non motorized lift for power wheelchairs, motorcycles, ATV's, self powered tillers, riding mowers and particularly to the manufacturing of low cost non motorized lifts that use the motorized rotating power of the carried vehicle as the source of energy to actuate the lifting mechanism.

### BACKGROUND OF INVENTION

A growing concern exists for persons who are physically challenged, have limited mobility or someone who simply require the transportation of motorized vehicles. The concern is one of cost and health. Technological advancements that lower the cost of a device to an end user always enrich the lifestyles of those who could not previously benefit of technology because of cost.

A tremendous percentage of people cannot afford a motorized wheelchair lift therefore eliminating their ability to use such a wheelchair in locations where they may be of great need. A market of any kind, a park or any location where the user is required to travel to in order to reach such location and then requires access to a motorized wheelchair to improve his or her access to items they desire. Without the ability to transport their motorized wheelchair such a person is stranded and many times emotionally challenged and harmed through their inability to get around and support their own lifestyle. Personal mobility is directly correlated to mental and physical health.

Large groups of people desire to transport motorized vehicles like ATV and riding mowers to a location where they can be of better use.

A lifting device without batteries and a motor alleviate many mechanical problems that exist in present lift systems. Failure caused by existing motorized lift incapacitates the user. In addition the elimination of an electrical source and motor substantially lower the manufacturing cost and labor incurred in manufacturing a lifting device.

### SUMMARY OF INVENTION

The present invention relates to a lift system attached to a vehicle comprising of a lift module and platform whose lift module is activated by the wheels of a powered wheel chair, motorcycle, ATV or any other powered vehicle's wheels which requires fail-proof and effortless transportation between two locations. Other objects and advantages of the present invention will become apparent and obvious from a study of the following description and the accompanying drawings, which are merely illustrative of such invention.

### BRIEF DESCRIPTION OF THE DRAWINGS

FIG. 1 is elevated view of an assembly drawing of lift.

FIG. 2 is the lifting device in the down position.

FIG. 3 is the platform at 45 degrees.

FIG. 4 is the platform in upright position for storage.

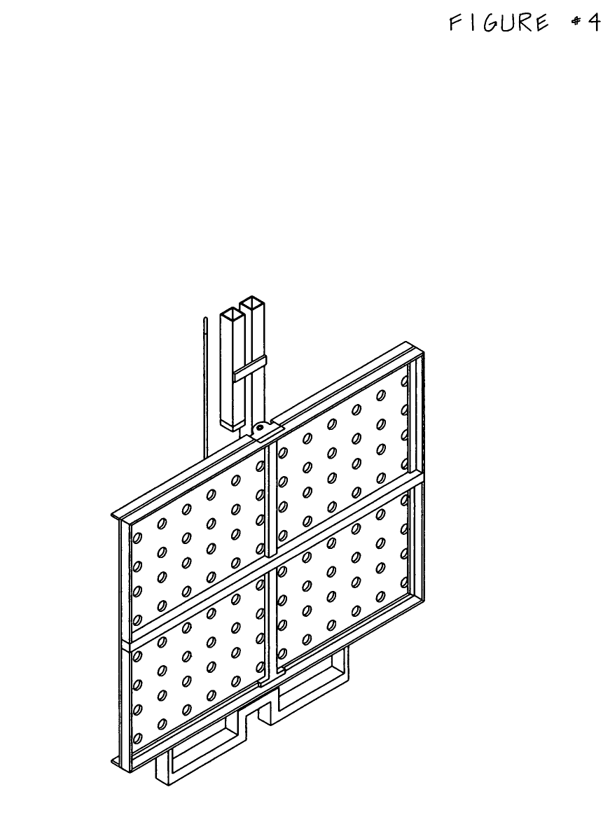

FIG. 5 is the platform frame.
FIG. 5 Part A (5A) are the tilt actuating bars, base and base mount.
FIG. 5 Part B (5B) are the swivel holes to vertical housing.
FIG. 5 Part C (5C) is the base platform frame.

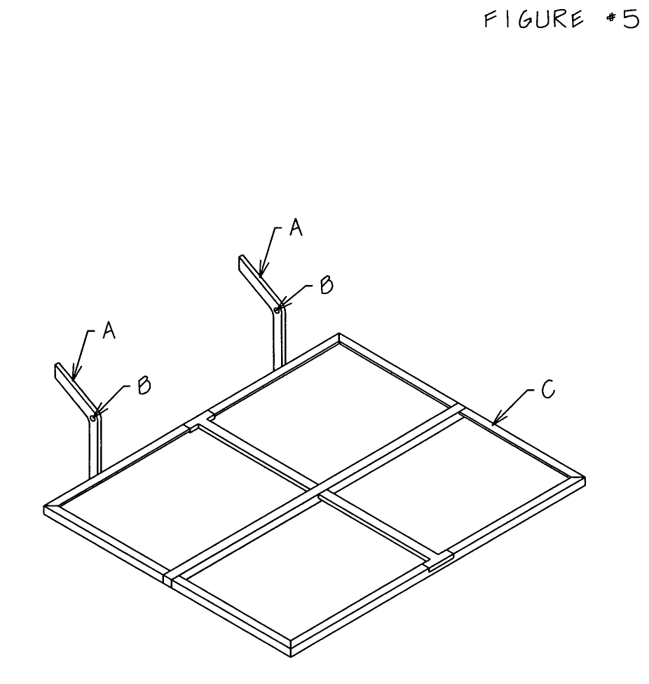

FIG. 6 Part A (6A) is the base platform cover.

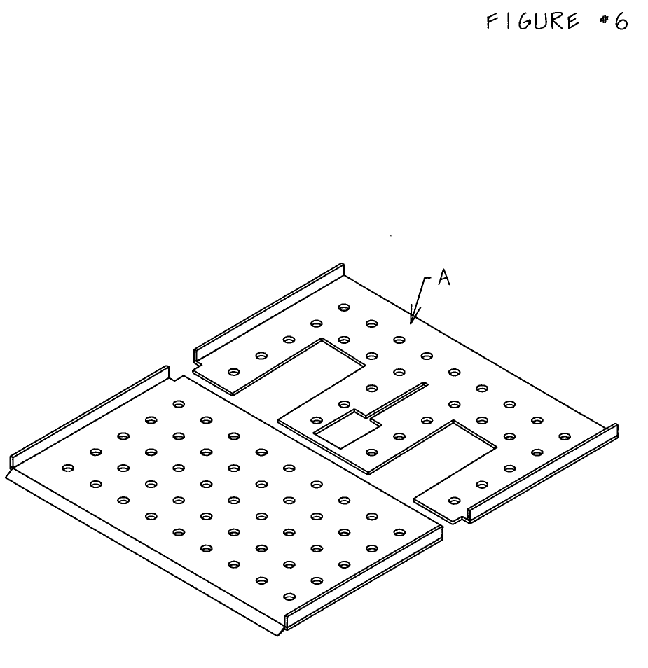

FIG. 7 is the roller and gear system to raise and lower the platform.
FIG. 7 Part A (7A) is the worm gear.
FIG. 7 Part B (7B) is the bell gear.
FIG. 7 Part C (7C) is the roller bar gear.
FIG. 7 Part D (7D) is the rotor bar.
FIG. 7 Part E (7E) is the rotor bar mount.

FIG. 8 is the Vertical Support Housing and platform Lift Coupling unit.
FIG. 8 Part A (8A) is the Vertical Support Housing unit.
FIG. 8 Part B (8B) is the tilting bar.
FIG. 8 Part C (8C) is the worm gear housing and platform lift coupling insert.
FIG. 8 Part D (8D) is the base & platform mounting bracket.
FIG. 8 Part E (8E) is the base and platform mounting holes.
FIG. 8 Part F (8F) is the automatic locking safety device & lever.

FIG. 9 is the Vertical Support Housing unit.
FIG. 9 Part A (9A) is a pulley.
FIG. 9 Part B (9B) is the worm gear clutch engaging bar.
FIG. 9 Part C (9C) is the clutch housing.
FIG. 9 Part D (9D) is the square housing.
FIG. 10 Part E (9E) is the tilting bar.

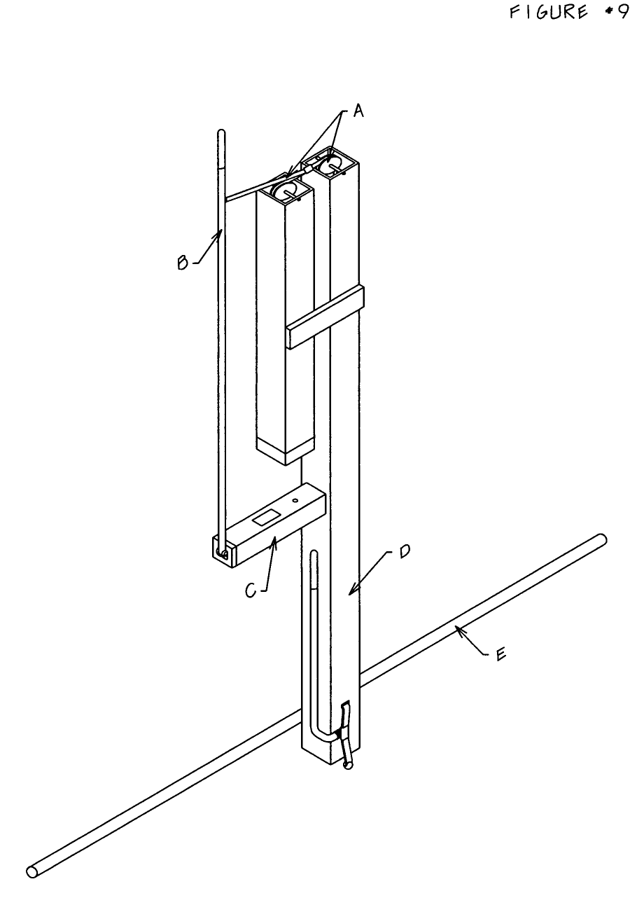

FIG. 10 is the internals of Vertical Support Housing, clutch and gears.
FIG. 10 Part A (10A) is the worm gear.
FIG. 10 Part B (10B) is the Vertical Support Housing.
FIG. 10 Part C (10C) is the worm gear clutch engaging bar.
FIG. 10 Part D (10D) are the nylon clutch washers.
FIG. 10 Part E (10E) are the washer and bearing support plates.
FIG. 10 Part F (10F) is a bearing.
FIG. 10 Part G (10G) is a bell gear.

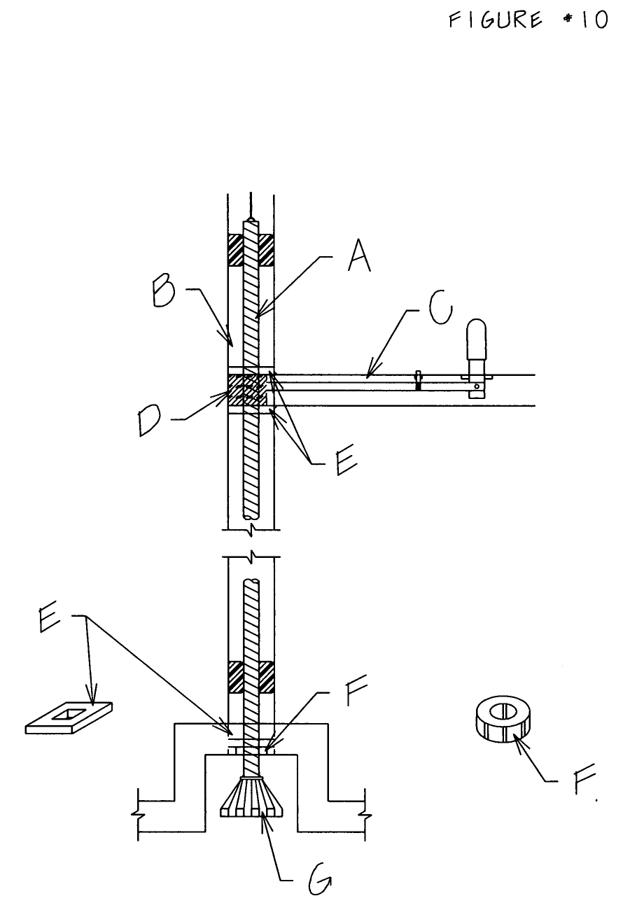

FIG. 11 is a safety-locking device on Vertical Support Housing.

### DETAILED DESCRIPTION OF THE INVENTION

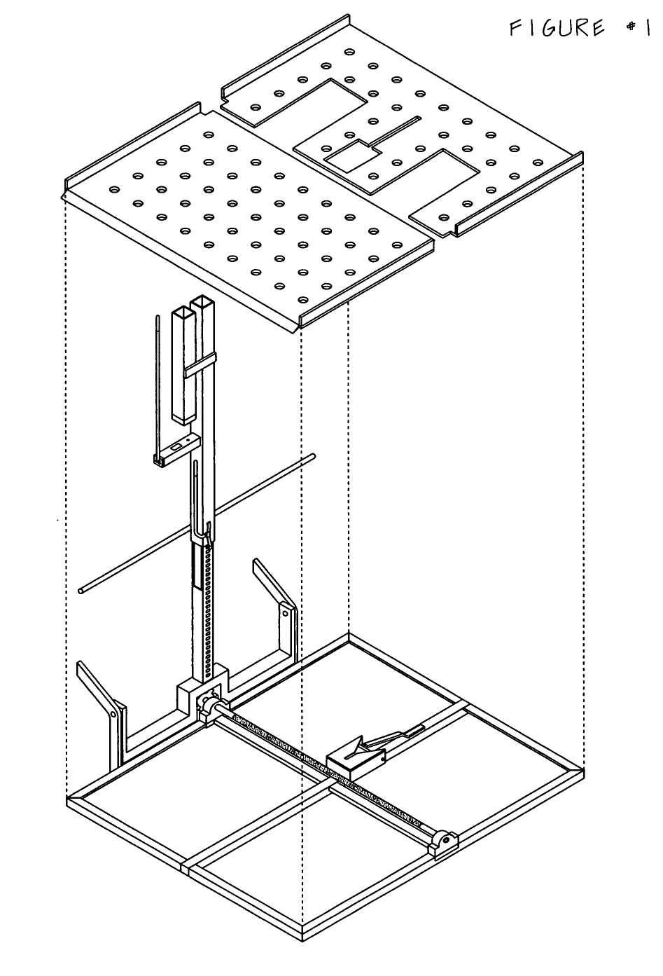

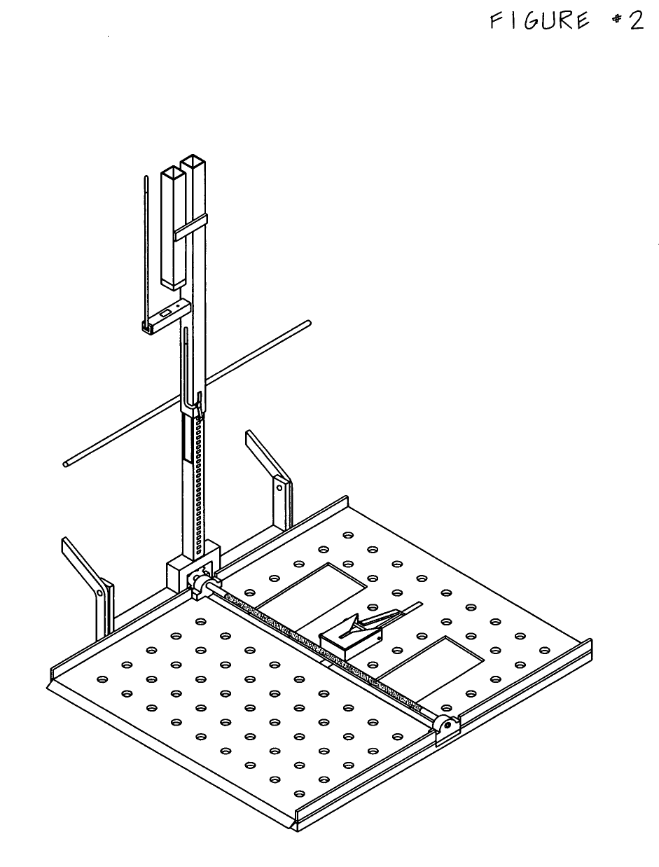

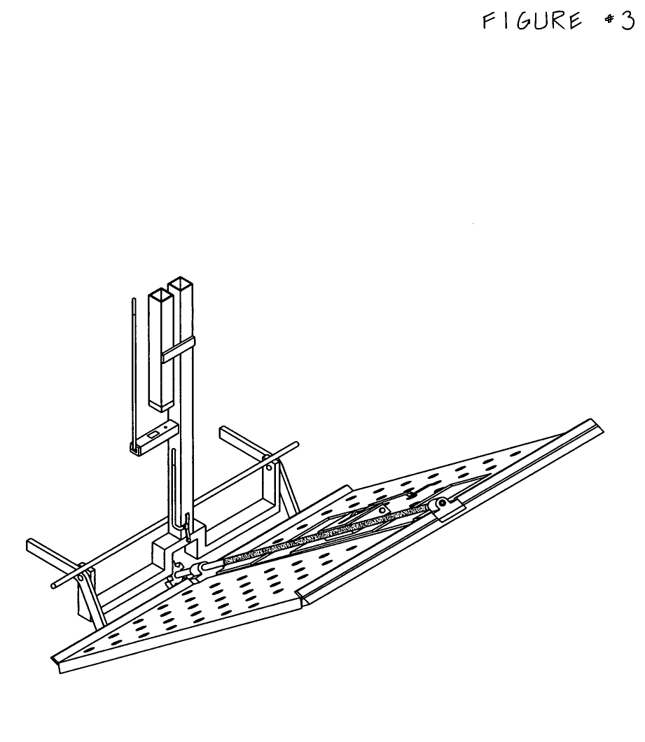

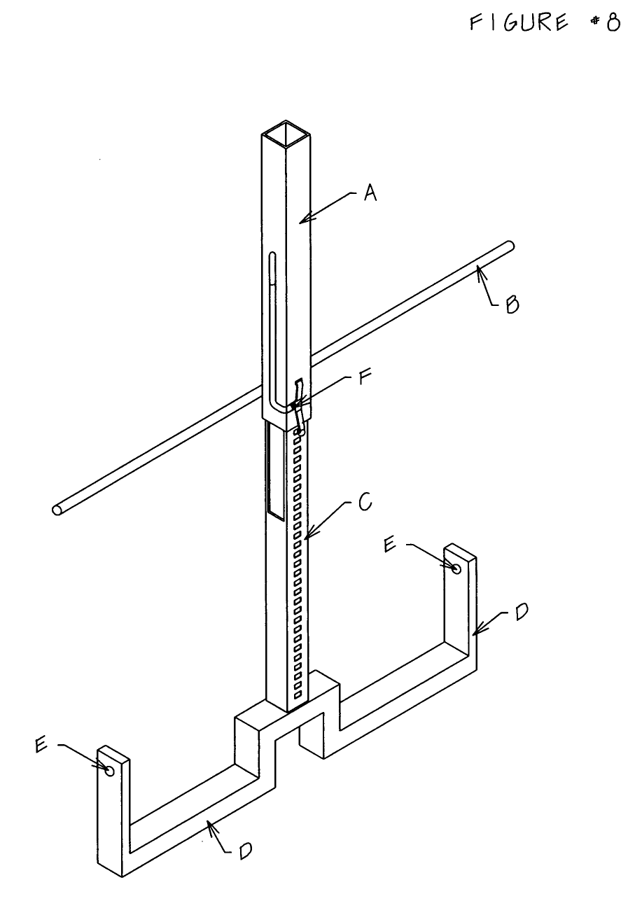

With further reference to the drawings, the wheelchair and lift system of the present invention is shown therein and indicated generally in FIGS. 1, 2, 3 & 4. Before discussing the system in detail, it may be noted that the basic system is comprised of a Vertical Support Housing 9, worm gear housing and coupling unit 8C & 8D, base & platform 5C & 6, rotor bar 7D and gear system in FIG. 8. In the embodiment illustrated in FIG. 1, the non-motorized lift has a base that can lift and tilt 1, 2, 3, and 4. In any event, a motorized wheel chair or vehicle can roll onto the platform 6A which is mounted on the base 5C and park its motorized wheels in the cut-outs on the platform while simultaneously engaging wheels with rotor bar 7D. Once the wheels are engaged, the motorized vehicle powers on and by spinning its wheels it spins the rotor bar 7D.

The rotor bar 7D is mounted in 7E to the base 5C so base 5C, platform 6A, and rotor bar 7D are one unit. As the rotor bar 7D spins it as well turns the affixed bar gear 7C. This in turn is coupled to the bell gear 7B, which then transfers the rotating force vertically through the worm gear 7A.

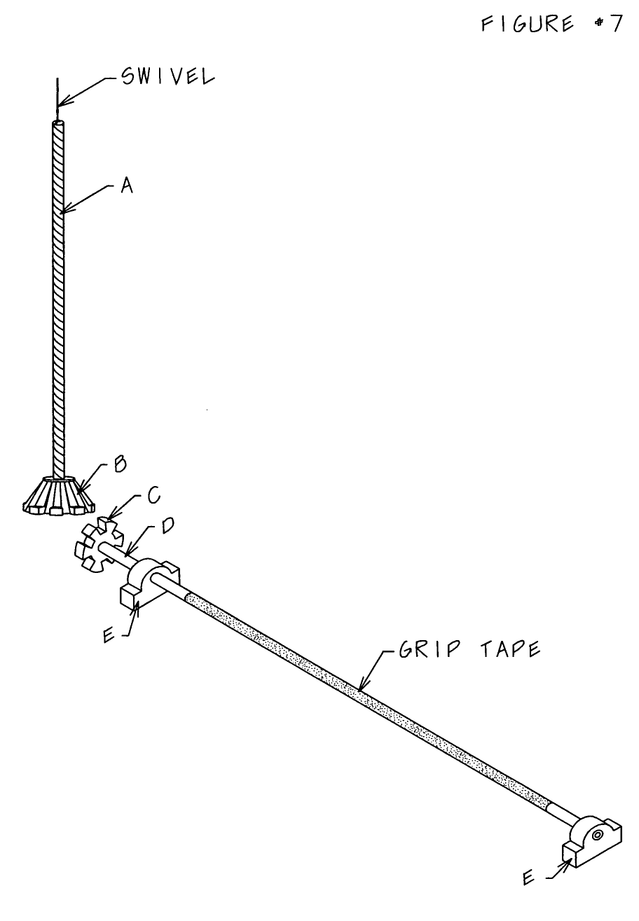

The base 5C is attached to the worm gear 7A; worm gear housing 8C and lift coupling insert 8C via the tilt actuating bars 5A. This coupling unites that base platform 5C & 6; gear system FIG. 7 and platform lift coupling insert 8C & 8D as ‘one’ unit. As the lift is actuated by the wheelchair's turning wheels on the rotor bar 7D, the entire unit described above lifts itself as an entire unit into the Vertical Support Housing 8A & 9. The worm gear 7A is threaded and as it spins it pulls itself up through the clutching device (9B, 10D, & 10E). The clutch applies sufficient pressure on the worm gear 7A via a high-pressure spring mounted inside the clutch housing 9C. The spring pressures the nylon washers 10D so that they compress the worm gear 7D. The washer and bearing support plates 10E keep the nylon washers in place. These support plates 10E affix the nylon washers to the Vertical Support Housing 8A & 9. The Vertical Support Housing is attached to an automobile and remains stationary. Since the Vertical Support Housing 8A & 9 are stationary and the clutch system is affixed within the Vertical Support Housing, as the worm gear turns within the nylon washers 10D & 10F it is forced to screw itself up or down therefore raising or lowering the platform assembly. One need only activate the worm gear clutch 9B so that the spinning worm gear is engaged. There exists an option of a simple 1-inch pulley system 9A within the Vertical Support Housing 8A & 9 for mechanical lifting advantage.

When the platform 6A is void of any vehicle is can be manually raised by disengaging the clutch system and lightly lifting. Once the platform 6A reaches a certain height the tilt actuating bars and base 5A will come into contact with tilting bar 8B & 9E. The angle and extension of the actuating bars 5A will come into contact with the bottom of tilt bar 8B and force the base and platform unit to tilt back. The higher the base is raised the farther back it will tilt until it reaches a 90-degree angle for storage.

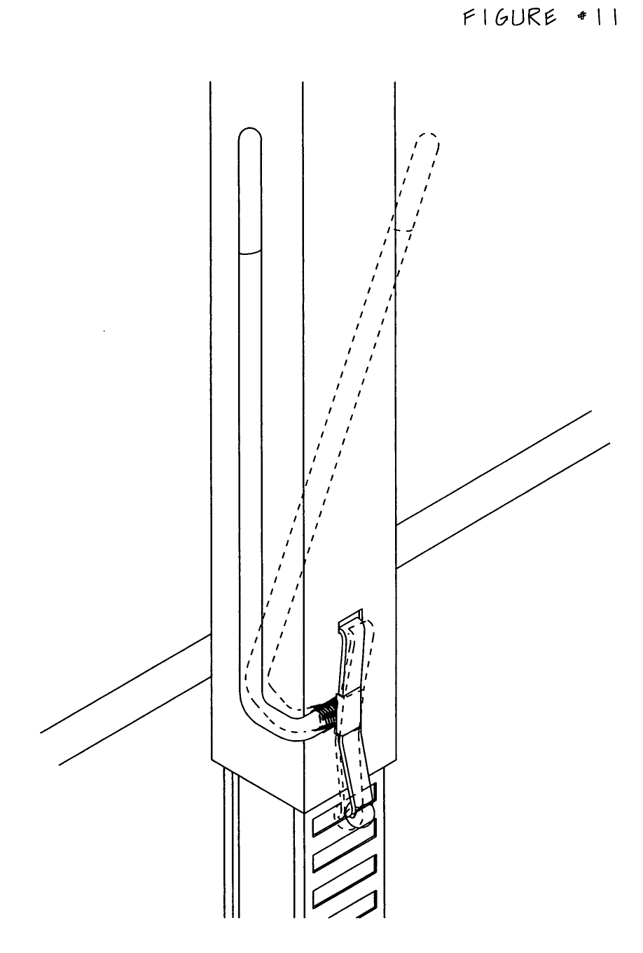

There are two safety devices on the lift. One is the clutch system. The nylon washers 10D (1″×1″ 2-piece nylon washer) cleat sufficient pressure to keep the worm gear 7A from spinning loosely and dropping the base 5C and platform 6A. A secondary safety device is the safety-locking device FIG. 11 on Vertical Support Housing 8A & 9. This is a manual device that is engaged at all times. To disengage unit one must pull and hold the automatic locking safety device & lever 8F. In the vent of a platform accident and failure of first safety device the secondary safety device 8F will automatically engage similar to a car ratcheting wheel jack.

Requirements: Tilt actuating bars 5A, ⅛″-½″ aluminum or steel formed or rolled at 45 degrees and welded to Base Frame. Swivel holes 5B, ¼″-½″ drilled or punched hole. Base platform frame 5C, ¼″-½″ aluminum or steel, cast or welded angle bars, solid or square tubing for interior supports, 30″W max×36″L max. Base platform cover 6A, ⅛″-½″ aluminum, punch and forged. Worm Gear 7A, ½″-1″ steel, machined, low thread count for increased speeds of raising and lowering. Bell Gear 7B, 2″ top belled to 4″ bottom, steel, machined—maintains contact with Roller Bar Gear 7C as Base Unit 5C angles up. Roller Bar Gear—standard 2″ steel spur gear.

*Note: in place of the Bell & Bar Gears 7C, can possibly use Diametric Pitch Gear Roller Bar 7D—1″ steel bar, rolled with weatherproof grip tape. Rotor Bar mount 7E—standard 1″ bearing with 3″ base bolted to Base Unit 5C with ¼″-½″ steel bolts.

Vertical Support Housing 8A, ⅛″-¼″×1½″ steel square tubing—attached to automobile. Tilting Bar 8B, ½″×24″ steel bar. Worm gear housing and platform lift coupling insert 8C, ⅛″-¼″×1″ steel square tubing. Base & platform mounting bracket 8D, ⅛″-½″ aluminum or steel, formed or machined and welded to worm gear housing and platform lift coupling insert. Base and platform mounting holes 8E, ¼″-½″ drilled or punched hole. Automatic locking safety device & lever 8F, heavy duty coil spring with ¼″-½″ machined steel double-sided lever—1 side with flat protruding arm (upward movement) and the other side with a ¼″-½″ roller bearing (downward movement); ¼″-½″ aluminum or steel bar. Pulleys 9A, Simple 1″ pulleys for mechanical lifting advantage; single pulley system with second pulley utilized to eliminate cable slack. Clutch Housing 9C—¾″ steel square tubing. Worm gear clutch engaging bar, ½″×¼″ aluminum or steel rubber covered handle with ⅛″ pivot pin, ⅛″ spring loaded pin, and ¼″ aluminum or steel rod attached to the Nylon Washer 10D. Nylon Washer 10D, 1″×1″ 2-piece nylon washer—engage and disengage worm gear threads. Washer and bearing support plate, 1½″×1½″×¼″-½″ aluminum or steel cast or punched with ⅗″ square hole. Bearing—1″ bearing with ½″ hole.

### SUMMARY

The present invention has numerous uses and advantages and may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed:

1. A non-motorized portable small vehicle lift and transport.

2. A lift activating mechanism, which is activated by rotating the wheels of a small-motorized vehicle, placed upon a rotor bar in a platform that then turns a gear system in claim 3.

3. A gear system that transfers the energy of the activating rotor mechanism in claim 2 into a vertical supporting housing, clutch and a worm gear that raises and lowers a lift platform.

4. A support system and housing that attaches the lift in claim 1 to a plurality of hitches and mounting methods.

5. A vertical support housing and platform system attached to activating mechanism in claim 2 that can lower a platform to the ground, raise the platform for small vehicle transportation.

6. A system in claim 5 with a user controllable safety-locking device that automatically locks in place to prevent accidental lowering and lifting of platform.

7. A pulley system attached to vertical support housing in claim 5 that assists lifting of activating mechanism platform and manual lifting of platform to 90 degree vertical for storage.

8. An adjustable clutch to engage worm gear in claim 3

9. A device in claim 1 by which a small vehicle is secured in place for safe lift activation, safe transportation and a deterrent from theft.
